(19) United States
(12) Patent Application Publication
(10) Pub. No.: US 2005/0190810 A1
(43) Pub. Date: Sep. 1, 2005

(54) Contact-bonded optically pumped semiconductor laser structure

(76) Inventors: Stuart Butterworth, San Jose, CA (US); Murray Reed, Menlo Park, CA (US); Dennis G. Fischer, Auburn, CA (US)

Correspondence Address: STALLMAN & POLLOCK LLP, SUITE 2200, 353 SACRAMENTO STREET, SAN FRANCISCO, CA, 94111, US

(21) Appl. No.: 10/788,820

(22) Filed: Feb. 27, 2004

(51) Int. Cl. H01S 3/091

(52) U.S. Cl. 372/70; 372/34; 372/99

(57) ABSTRACT

An optically pumped semiconductor (OPS) structure includes a multilayer gain-structure surmounting a mirror structure. One surface of a diamond heat spreader is attached to the mirror structure via a contact bond. The opposite surface of the heat spreader is bonded to a metal heat sink. In one example, the OPS-structure also has a diamond window contact bonded to the gain-structure.

### TECHNICAL FIELD OF THE INVENTION

The present invention relates generally to heat removal devices for optically pumped semiconductor (OPS) laser structures. The invention relates in particular to contact bonding high thermal conductivity material to such a structure for use as a heat sink window or heat spreader.

### DISCUSSION OF BACKGROUND ART

An OPS-structure usually includes a multilayer mirror structure (Bragg Mirror) structure of dielectric or semiconductor materials surmounted by a multilayer gain-structure. The gain-structure layers are all epitaxially grown layers of semiconductor materials. The gain-structure includes a plurality of quantum-well layers spaced apart by spacer layers.

In a common type of laser including an OPS-structure, a laser resonator is formed between the Bragg mirror structure and an external mirror. Optical pump light is directed into the gain-structure through the front or edge thereof. The pump light is absorbed by material of the spacer layers, thereby creating electrical carriers. The electrical carriers are attracted into, trapped in, and recombine in the quantum-well layers. The recombination of the electrical carriers causes light emission at a wavelength characteristic of the material of the quantum-well layers. The emitted light circulates in the resonator as laser radiation. Laser radiation exits the resonator through the external mirror thereof. Absorbed pump light that is not converted by the gain-structure into laser radiation causes heat build-up in the OPS-structure. This heat build-up is one problem that has limited scaling up the power output of OPS lasers to compete with that of solid-state lasers.

One prior-art method of limiting heat build-up in the OPS-structure of an OPS laser is to solder bond the OPS-structure, Bragg mirror side down, onto a diamond heat spreader. The diamond heat spreader is in turn bonded to a water-cooled copper heat sink. One limitation of this method is the thickness of the OPS-structure itself. As this structure is formed from layers of materials that have relatively low thermal conductivity, there is no easy path for heat to travel through the structure to the diamond heat spreader. Another limitation is that the solder bonds themselves can be as much as about 40 time less thermally conductive than the diamond of the diamond heat spreader, and as much as about 10 times less thermally conductive than metal of the heat sink. Because of this, even one solder bond can add considerable resistance to the passage of heat. A further limitation is that through a combination of thermally induced stresses, and soft-soldered bonds between the diamond spreader and the OPS-structure, the OPS-structure can buckle to an extent that lasing is no longer possible. There is a need for an improvement in methods of heat removal in OPS-structures.

### SUMMARY OF THE INVENTION

In one aspect of the present invention an optically pumped semiconductor laser component comprises a multilayer structure including a mirror structure surmounted by a multilayer gain-structure and at least one heat conducting element having a high thermal conductivity and having first and second opposite surfaces. The heat-conducting element is contact-bonded via the first surface thereof to one of the mirror structure and the gain-structure.

In one preferred embodiment, the heat-conducting element is a crystal diamond plate. The first surface of the plate is contact bonded to the mirror structure and the second surface of the plate is solder bonded to a water-cooled copper heat sink.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIGS. 1A-G schematically illustrate one preferred method in accordance with the present invention of fabricating an OPS-structure including a gain-structure and a mirror-structure, contact bonding the OPS-structure onto a diamond heat spreader, and bonding the OPS-structure and heat spreader onto a heat sink.

FIGS. 2A-E schematically illustrate another preferred method in accordance with the present invention of fabricating an OPS-structure including a gain-structure and a mirror-structure, and contact bonding the OPS-structure onto a diamond heat spreader previously bonded onto a heat sink.

FIGS. 3A-F schematically illustrate yet another preferred method in accordance with the present invention of fabricating an OPS-structure including a gain-structure and a mirror-structure, contact bonding a diamond window onto the gain-structure of the OPS-structure to form a windowed OPS-structure, and bonding the mirror structure of the windowed OPS-structure onto a heat sink.

FIGS. 4A-C schematically illustrate one preferred method in accordance with the present invention of contact bonding the windowed OPS-structure of FIG. 3E onto a diamond heat spreader to form a diamond-sandwiched OPS-structure, and then bonding the diamond heat spreader of the diamond-sandwiched OPS-structure to a heat sink.

FIGS. 5A-B schematically illustrate another preferred method in accordance with the present invention of contact bonding the windowed OPS-structure of FIG. 3E onto a diamond heat spreader previously bonded to a heat sink to form a diamond-sandwiched OPS-structure bonded to the heat sink.

FIGS. 6A-B schematically illustrate yet another preferred method in accordance with the present invention of contact bonding a diamond window onto the gain-structure of the heat sink-supported OPS-structure of FIG. 1G.

### DETAILED DESCRIPTION OF THE INVENTION

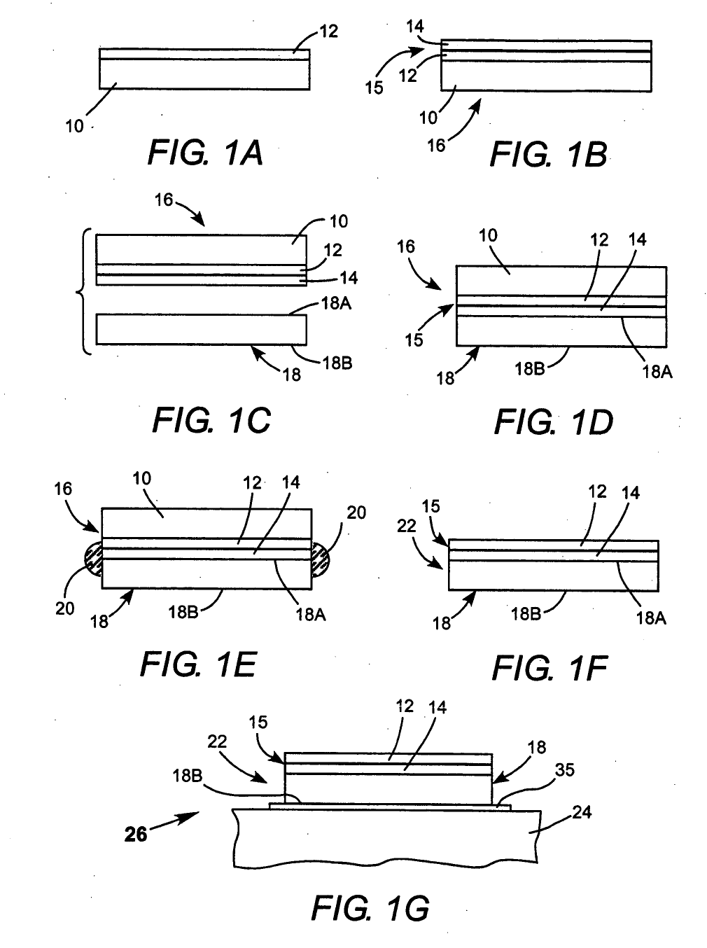

Referring now to the drawings, wherein like features are designated by like reference numerals, FIGS. 1A-G schematically illustrate one preferred method in accordance with the present invention of fabricating an assembly 26 of an OPS-structure 15 on a heat sink 24 (see FIG. 1G). OPS-structure 15 includes a gain-structure 12 and a Bragg mirror structure 14. A diamond heat spreader 18 is located between Bragg mirror structure 14 of OPS-structure 15 and the heat sink. Heat spreader 18 preferably has a thickness greater than about 300 micrometers (Jim). Fabrication steps are as follows.

Multilayer gain-structure 12 is epitaxially grown on a single crystal substrate 10 (see FIG. 1A). The material of the substrate is selected according to the material of the layers the OPS-structure. The substrate material, for example, may be gallium arsenide (GaAs) or Indium Phosphide (InP). Next, Bragg mirror structure 14 is deposited or grown on gain-structure 12 see (FIG. 1B) forming an assembly or “chip” 16 comprising OPS-structure 15 and the substrate. Bragg mirror structure 14 may be formed from layers of semiconductor materials epitaxially grown, or from vacuum deposited polycrystalline or amorphous layers of dielectric materials or a combination of dielectric layers and metal layer.

Chip 16 is then inverted or “flipped” and positioned over a surface 18A of diamond heat spreader 18 (see FIG. 1C). Chip 16 including OPS-structure 15 is contact bonded to surface 18A of the diamond heat spreader, here, with Bragg mirror structure 14 in contact with the heat spreader as depicted in FIG 1D. The term “contact bonded”, in this description and the appended claims, means that a bond is formed without a physical adhesive between the bonded members. Such a bond is comparable to an “optical contact” that is sometimes used in the optical industry to form an adhesive-free bond between smooth, flat components of optically transparent, solid materials such as glass or fused silica. Once the contact bond has been formed, it is preferable, albeit not necessary, to heat or anneal the bonded assembly at a temperature between about 100° C. and 350° C.

After chip 16 has been contact bonded to the diamond heat spreader, a bead 20 of a sealant such as photoresist or epoxy is preferably applied around the perimeter of the contact bond to inhibit ingress of fluid (see FIG. 1E). Next, substrate 10, on which OPS-structure 15 is grown, is etched away to reveal gain-structure 12. This forms a new chip 22 (see FIG. 1F) in which OPS-structure 15 is now supported by heat spreader 18.

Chip 22 is then bonded to heat sink 24 via at least a solder layer 35 between surface 18B of the diamond heat spreader and the heat sink (see FIG. 1G). Methods of solder bonding diamond heat spreaders to metal heat sinks are well known in the art and accordingly are not described in detail herein. It should be noted, however, that solder bonding heat spreader 18 to heat sink 24 should not be construed as limiting the method of the present invention.

Diamond heat spreader 18 may be in a crystalline form, which is clear and commercially available already having a smooth surface to which a contact bond can be made after a minimum of preparation. Heat spreader 18 may also be formed from chemical vapor deposited (CVD) diamond, which may have a translucent appearance. Synthetic diamond in crystalline and CVD form can be obtained from Harris International Corporation of New York, N.Y. In the case of CVD diamond it may be preferable to polish the surface to which the contact bond is to be made. Alternatively a hard dielectric coating may be applied to a rough surface of a CVD diamond substrate and this coating may be polished smooth so that the CVD diamond substrate can be optically contacted.

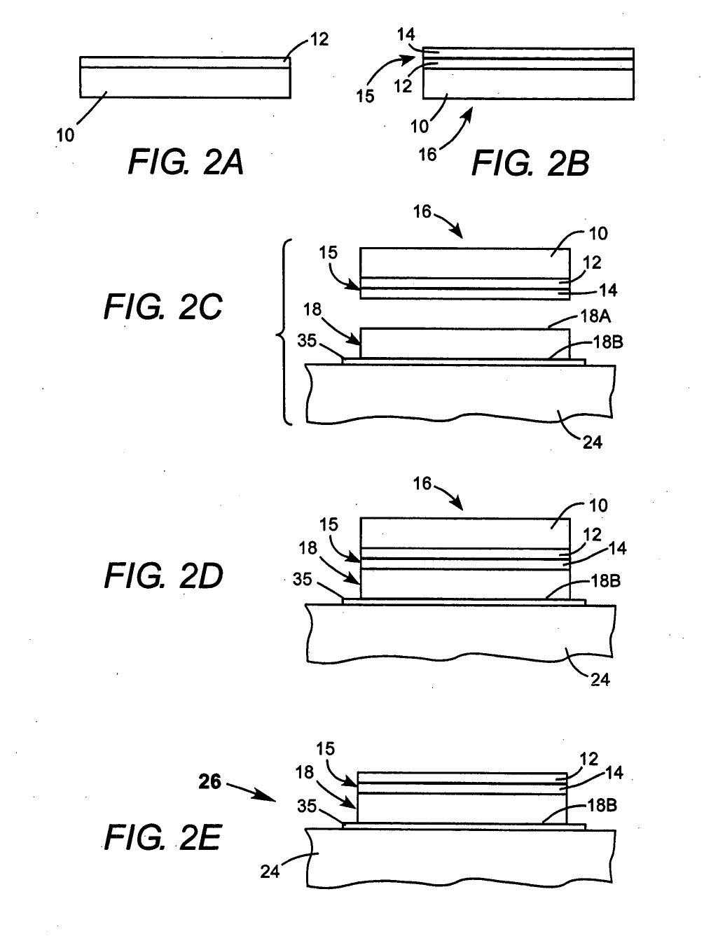

FIGS. 2A-E schematically illustrate another preferred method in accordance with the present invention of fabricating an assembly 26 of an OPS-structure 15 on a heat sink 24 (see FIG. 1G). Multilayer gain-structure 12 is epitaxially grown on a single crystal substrate 10 (see FIG. 2A). Next, Bragg mirror structure 14 is deposited or grown on gain-structure 12 (see FIG. 2B) forming chip 16 comprising OPS-structure 15 and the substrate, as discussed above with reference to FIG. 1A and FIG. 1B. Chip 16 is inverted and positioned over a diamond heat spreader 18, having surface 18A thereof already prepared for contact bonding as discussed above, and having surface 18B thereof bonded to heat sink 24 via a solder layer 35 (see FIG. 2C). Chip 16 is contact bonded to diamond heat spreader 18 via Bragg mirror structure 14 of OPS-structure 15 (see FIG. 2D). Finally, substrate 10 of chip 16 is etched away to expose gain-structure 12 of OPS-structure 15.

In embodiments of the method of the present invention described above, the method is directed to contact bonding a diamond heat spreader to be located between an OPS-structure and a metal heat sink. The diamond heat spreader, here, provides an effective path for extracting heat from the OPS-structure then transferring the heat to the metal heat sink. In embodiments of the present invention discussed below, a diamond heat spreader or heat sink in the form of an optical window, transparent to pump light and laser radiation, is contact bonded to the emitting side of the OPS-structure, i.e., to the gain-structure of the OPS-structure. This also provides a means for extracting heat from the OPS-structure and can be used with or without an above-described “Bragg-mirror-side” heat spreader 18. Window 19 preferably has a thickness greater than about 300 μm. Window 19 may also be formed from sapphire (crystalline aluminum oxide).

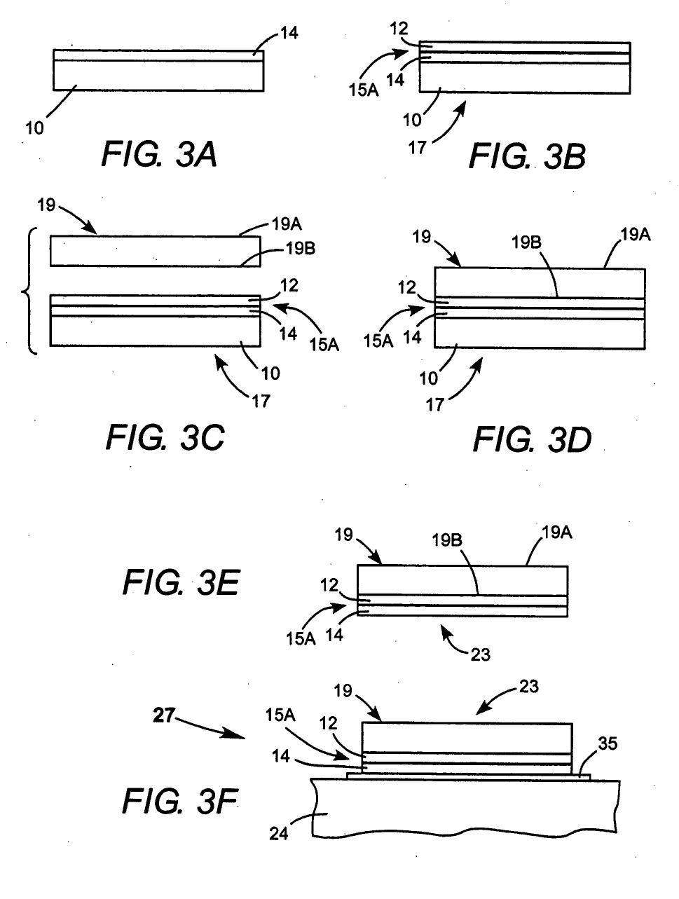

FIGS. 3A-F schematically illustrate one preferred method in accordance with the present invention of fabricating an assembly 27 of an OPS-structure 15A on a heat sink 24 (see FIG. 3F). OPS-structure 15A includes a gain-structure 12 and a Bragg mirror structure 14. A diamond window 19 is contact bonded to gain-structure 12 of the OPS-structure. Fabrication steps are as follows. Window 19 is functionally similar to heat spreader 18 inasmuch as the purpose of both elements is to conduct heat away from OPS-structure. The term “window” is used here for element 19 in deference to the fact that it must be transmissive to at least the laser radiation generated by the OPS-structure and the wavelength of pump-light. Heat spreader 18 and window 19 may be collectively referred to as heat conductive elements or plates. In the illustrated embodiments, heat spreader 18 aids in conduction of the heat away from the OPS-structure to a separate heat sink. Window 19, on the other hand, acts to draw heat away from the OPS-structure as well as acting as a heat sink. It is within the scope of the subject invention to attach a separate heat sink to window 19, however, such a heat sink must be configured so as not to block incoming pump radiation or circulating laser radiation.

Bragg mirror structure 14, here, of semiconductor material layers, is epitaxially grown on a single crystal substrate 10 (see FIG. 3A). The material of the substrate is selected according to the material of the layers the OPS-structure as discussed above. Next, gain-structure 12 is epitaxially grown on Bragg mirror structure 12 see (FIG. 3B) forming a chip 17 comprising OPS-structure 15A and the substrate. Chip 17 is then inverted and diamond window 19 is positioned over the chip with surface 19B of the diamond window facing gain-structure 12 (see FIG. 3C). Window 19 is then contact bonded to the gain-structure as depicted in FIG. 3D. After window 19 has been contact bonded to chip 17, substrate 10 on which OPS-structure 15A is grown, is etched away to reveal Bragg mirror structure 14. This forms a new chip (windowed OPS-structure) 23 (see FIG. 3E) in which OPS-structure 15A is now supported by window 19. Bragg mirror structure 14 of chip 23 is then bonded to heat sink 24 via a solder layer 35 to complete the assembly (see FIG. 3F).

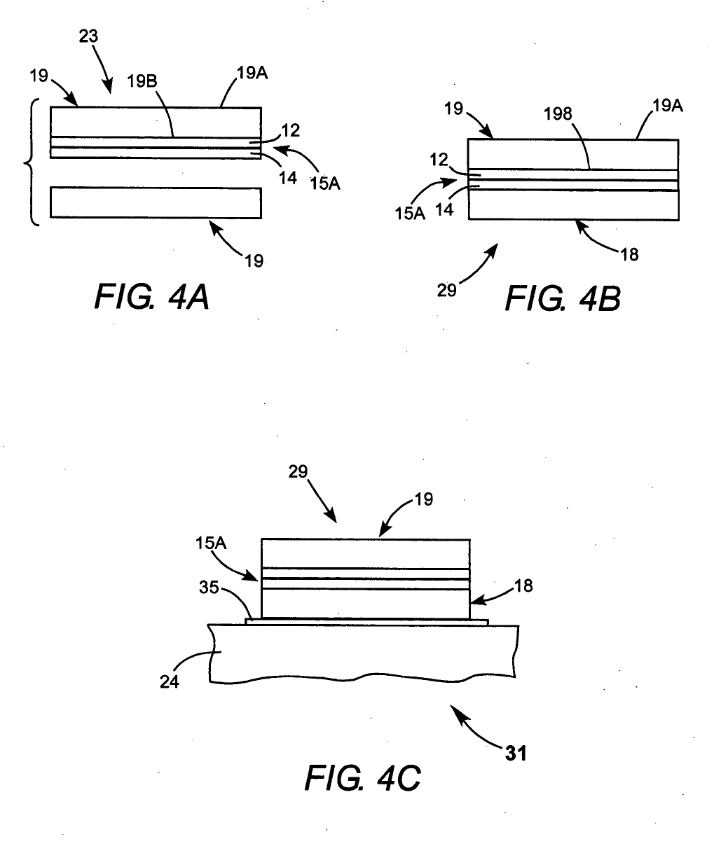

As noted above, an OPS-structure in accordance with the present invention may include a contact-bonded, Bragg-mirror-side diamond heat spreader 18, in addition to a gain-structure-side diamond window 19. Methods in accordance with the present invention for forming such a structure are discussed below beginning with reference to FIGS. 4A-C. Here, a chip 23 including an OPS-structure 15A on a diamond window 19 is formed as discussed above with respect to FIGS. 3A-E. The chip 19 is positioned over a diamond heat spreader 18 (see FIG. 4A) and contact bonded to the heat spreader to form a chip 29 in which OPS-structure 15A is “sandwiched” between a diamond window and a diamond heat spreader. Chip 29 is then solder bonded to a heat sink 24 to complete an assembly 31 having the diamond-sandwiched OPS-structure supported by a heat sink.

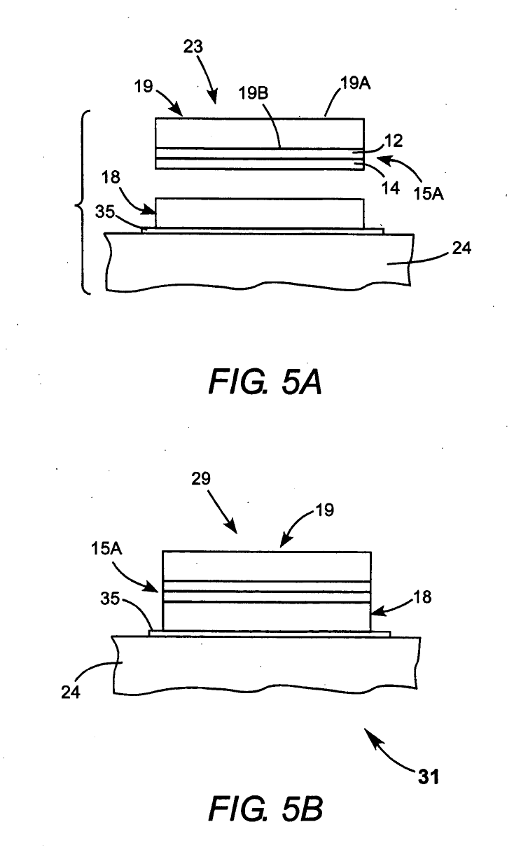

FIG. 5A and FIG. 5B depict steps in another method of forming an assembly 31. Here, a chip 23 including an OPS-structure 15A on a diamond window 19 is formed as discussed above with respect to FIGS. 3A-E. The chip 19 is then positioned over a diamond heat spreader 18 previously solder bonded onto a heat sink 24 (see FIG. 5A). The chip is then contact bonded to the heat spreader to complete the assembly 31 having the diamond-sandwiched OPS-structure supported by a heat sink.

A disadvantage of forming an assembly 29, as discussed above with respect to FIGS. 3A-F, or an assembly 31 as discussed above with respect to FIGS. 4A-C and FIGS. 5A-B, is that Bragg mirror structure 14 must be epitaxially grown on substrate so that gain-structure 12 can be epitaxially grown. In order to epitaxially grow the Bragg mirror there can only be a relatively small difference in composition of the high index semiconductor material and the low index semiconductor material of the Bragg mirror structure for reasons well known to those skilled in the art to which the present invention pertains. The small difference in composition results in a small difference in the refractive indices of the high and low refractive index semiconductor materials. Accordingly, thirty or more layers of material may be necessary to provide an adequate reflectivity, for example greater that 99 percent, for the Bragg mirror structure. In this case, the mirror structure may have a physical thickness of 2.5 micrometers (μm) or greater. As the Bragg mirror layers typically have relatively low thermal conductivity, this thickness can provide an unacceptable resistance to heat transfer to heat sink 24 either directly or via a diamond heat spreader 18. If gain-structure 12 is grown first on substrate 10, as described above with respect to FIGS. 1A-E, Bragg mirror structure 14 need not be epitaxially grown. In this case, the Bragg mirror structure may be formed by a combination of a metal layer and as few as two dielectric layers providing a total dielectric thickness of less than 0.3 μm. This is significantly thinner than an epitaxially grown mirror of the same reflectivity, and accordingly has less stress and less resistance to heat transfer.

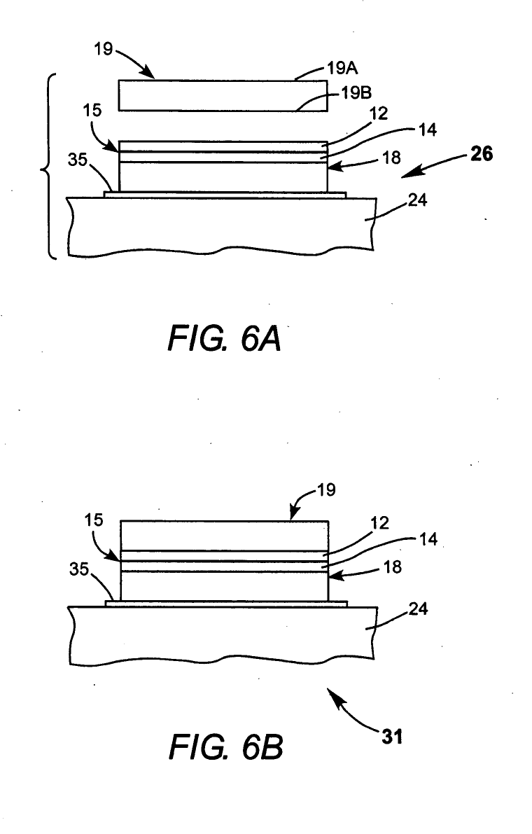

FIG. 6A and FIG. 6B schematically illustrate steps in accordance with the present invention for forming an assembly 31 having the diamond-sandwiched OPS-structure supported by a heat sink, and in which a Bragg mirror structure 14 does not need to be epitaxially grown. FIG. 6A schematically depicts a diamond window 19 positioned over an assembly 26 fabricated as discussed above with respect to either FIGS. 1A-G or FIGS. 2A-E. An assembly 31 is completed simply by contact bonding window 19 onto gain-structure 12 of OPS-structure 15 of the assembly.

In all of the above-discussed OPS-structures, both heat spreader 18 and window 19 are described as being diamond components. In the case of heat spreader 18 this is most preferable. There is little point in providing a heat spreader that has a lower thermal conductivity than the material of the heat sink on which it is to be bonded and all forms of diamond have a higher thermal conductivity than metals that are usually preferred for manufacturing heat sinks. By way of comparison, CVD diamond, which has the lowest thermal conductivity of the diamond forms, still has a thermal conductivity more than four times that of copper. Heat spreader 18 does not need to be transparent. Accordingly, the heat spreader may be made from clear, crystal diamond, or from translucent, optically scattering, CVD diamond. As the thermal conductivity of the various forms of diamond is grouped within a narrow range about 10% of some nominal value, the choice of diamond can be based on other factors such as transparency, surface smoothness, or the ability to be polished to a smooth surface. Heat spreader 18 could also be made for another high thermal conductivity material that has a higher thermal conductivity than copper, such as silicon carbide (SiC) or copper:diamond (Cu:Diamond). None of these materials has a thermal conductivity exceeding that of diamond.

Window 19 may be of a material other than diamond, provided that it is essentially non-absorbing for the pump light and laser radiation wavelengths of the OPS-structure, and preferably has a thermal conductivity higher than the materials of the gain-structure. Clearly the higher the thermal conductivity of the window, the more effective will be the heat removal provided by the window. Crystal diamond has the highest thermal conductivity of any candidate window material and is transparent to wavelengths between about 300 nm and 7000 nm and between 8000 nm and 100 μm or greater.

It is preferable when optically contacting a diamond (CVD, natural or type IIa-synthetic) or any other highly thermally conductive heat spreader material to a semiconductor epitaxial layer structure, that the surfaces of both the layer structure and the heat spreader be very clean and very flat, preferably flattter than 0.2 waves at 635 nm. Standard optical contacting methods are used, well known in the industry. Regarding cleanliness, it is preferable that contacting be carried out on a class 100 clean bench and that surfaces be finally cleaned with an organic solvent such as acetone, methanol and iso-propanol. Once the heat spreader and the semiconductor chip are clean, one edge of the semiconductor chip is pressed against the heat spreader and the two surfaces are brought into contact with pressure. This usually requires multiple attempts of recleaning and contacting. Once a full surface optical contact has been made, the contacted, assembled structure is annealed at temperatures between 100° C. and 350° C. Then the substrate supporting the semiconductor epitaxial layer structure is etched away, leaving the finished optical semiconductor device optically contacted to the heat spreader material. This assembled structure is then soldered to a copper heat sink. This optical contact method can be done at a single device level or, alternatively, at a wafer level (multiple semiconductor devices on a single substrate or wafer) for high volume assembly. If contacted at a wafer level the contacted structures on the wafer are diced into individual chips after contacting and etching, and then each individual chip is soldered to a heat sink.

In one example of a heat sink-mounted OPS-structure in accordance with the present invention, a complete OPS-structure including a gain-structure having quantum well-layers of indium gallium arsenide (InGaAs) and spacer layers of aluminum gallium arsenide (AlGaAs) and aluminum gallium arsenide phosphide (AlGaAsP), with Bragg mirror structure of comprising alternating layers of aluminum arsenide ((AlAs) and gallium arsenide (GaAs) was contact bonded, Bragg mirror structure down, by the method of FIGS. 1A-G onto a CVD-diamond heat spreader 18. The OPS-structure was in the form of a chip having dimensions 2 mm×2 mm. The diamond heat spreader has a square shape 2.65 mm×2.65 mm and had a thickness of 300 micrometers (μm). A bead of photoresist was used to protect the optical contact while substrate 10 was etched away. The diamond heat spreader 18 was then soldered onto a copper heat sink. The mounted OPS-chip was used in an external resonator OPS-laser pumped with about 54 watts of radiation having a wavelength of about 810 nm. This provided 14 Watts of output power at a wavelength of about 920 nm in a multimode beam. Although some minor delamination of the contact bond was experienced it did not affect the laser output.

The present invention is described above in terms of a preferred and other embodiments. The invention is not limited, however, to the embodiments described and depicted. Rather, the invention is limited only by the claims appended hereto.

1. An optically pumped semiconductor laser component, comprising:
a multilayer structure including a mirror structure surmounted by a multilayer gain-structure; and
at least a first heat conducting element having a high thermal conductivity and having first and second opposite surfaces, said heat-conducting element being contact-bonded via said first surface thereof to one of said mirror structure and said gain-structure.

2. The component of claim 1, wherein the thermal conductivity of said first heat conducting element is greater than the thermal conductivity of copper.

3. The component of claim 1, wherein said first heat conducting element is contact bonded to said mirror structure.

4. The component of claim 3 wherein said mirror structure is a multilayer semiconductor structure.

5. The component of claim 3 wherein said mirror structure is a multilayer dielectric structure.

6. The component of claim 3, wherein said mirror structure includes a metal layer and one or more dielectric layers.

7. The component of claim 3, further including a second heat-conducting element having first and second opposite surfaces, said first surface of said second heat conducting element being contact bonded to said gain-structure.

8. The component of claim 7, wherein said gain-structure emits light at a laser wavelength in response to being optically pumped by light having a pump wavelength, and said second heat conducting element is transparent to said pump wavelength and said laser wavelength.

9. The component of claim 8, wherein said second heat conducting element is one of a diamond element and a sapphire element.

10. The component of claim 1, wherein said first heat-conducting element is a diamond element.

11. The component of claim 10, wherein said second surface of said first heat-conducting element is in thermal contact with a heat sink.

12. The component of claim 11, wherein said heat sink is a copper heat sink.

13. The component of claim 1, wherein said first surface of said first heat conducting element is contact bonded to said gain-structure.

14. The component of claim 13, wherein said gain-structure emits light at a laser wavelength in response to being optically pumped by light having a pump wavelength, and said second heat conducting element is transparent to said pump wavelength and said laser wavelength.

15. The component of claim 15, wherein said second heat conducting element is one of a diamond element and a sapphire element.

16. An optically pumped semiconductor laser component, comprising:
a multilayer structure including a mirror structure surmounted by a multilayer gain-structure; and
at a diamond heat spreader element having first and second opposite surfaces, said heat spreader element being contact-bonded via said first surface thereof to one of said mirror structure and said gain-structure.

17. The component of claim 16, wherein said heat spreader element is contact bonded to said mirror structure.

18. The component of claim 16 wherein said diamond heat spreader element is formed from one of crystal diamond or CVD diamond.

19. A method of mounting an OPS-structure on a heat sink, comprising the steps of:
providing a heat spreader element having first and second opposite surfaces and having thermal conductivity higher than the thermal conductivity of the heat sink;
contact bonding the OPS-structure to said first surface of said heat spreader element; and
bonding said second surface of said heat spreader element to the heat sink.

20. The method of claim 19, wherein said second surface of said heat spreader element is bonded to the heat sink by solder bonding.

21. A method of mounting an OPS-structure on a heat spreader element, comprising the steps of:
growing a multilayer semiconductor gain-structure on a substrate;
growing a mirror structure on said gain-structure;
contact bonding a surface of the heat spreader element to said mirror structure; and
etching away said substrate to expose said gain-structure.
